(19) United States
(12) Patent Application Publication
(10) Pub. No.: US 2026/0045389 A1
(43) Pub. Date: Feb. 12, 2026

(54) ELECTRONIC COMPONENT

(71) Applicant: Panasonic Intellectual Property Management Co., Ltd., Osaka (JP)

(72) Inventors: TAKASHI OHBAYASHI, Osaka (JP); HIROYUKI YOSHIMURA, Osaka (JP); HIROKATSU ITO, Fukui (JP); KOUHEI KITAZAWA, Fukui (JP)

(21) Appl. No.: 19/100,790

(22) PCT Filed: Aug. 23, 2023
(86) PCT No.: PCT/JP2023/030346

§ 371 Date: Feb. 3, 2025

(30) Foreign Application Priority Data
Sep. 16, 2022 (JP) 2022-148380

(51) Int. Cl. H01C 1/032; H01C 17/00; H01C 17/242

(52) U.S. Cl. CPC H01C 1/032; H01C 17/006; H01C 17/242

(57) ABSTRACT

Provided is an electronic component having a small change in characteristics due to moisture. Electronic component includes substrate, element part, and insulating protective layer. Element part is formed on substrate. Insulating protective layer covers element part. Element part includes trimming groove. Insulating protective layer includes cover part containing a cured product of polysilsesquioxane. Cover part includes surface cover layer covering a surface of element part and filling part filled in trimming groove.

### TECHNICAL FIELD

The present disclosure relates generally to electronic components. More specifically, the present disclosure relates to an electronic component including an element part on a substrate.

### BACKGROUND ART

PTL 1 describes a method for producing a fixed resistor. In this production method, first, a resistor body is formed on a base of an insulator. Next, on the surface of the body of the resistor on which the resistor body is formed, a smokeless coating material is applied. The smokeless coating material is formed by mixing an organosilsesquioxane of a trifunctional unit and a silicate of a tetrafunctional unit to form silanol, and condensing the silanol. Next, a display is formed on the surface of the body of the resistor using a display material including a metal oxide-based polymer and an inorganic filler. Next, the body of the resistor is subjected to a heat treatment at a temperature of 100° C. to 200° C. in a vacuum furnace to volatilize the organic component of the coating material, leaving a polymer of silicon oxide with less amount of organic component on the surface of the body of the resistor.

### CITATION LIST

### Patent Literature

PTL 1: Japanese Patent No. 3645014

### SUMMARY OF THE INVENTION

In an electronic component such as a resistor as described above, it has been desired to reduce a change in characteristics due to moisture.

An object of the present disclosure is to provide an electronic component having a small change in characteristics due to moisture.

An electronic component according to one aspect of the present disclosure includes a substrate, an element part formed on the substrate, and an insulating protective layer covering the element part. The element part includes a trimming groove. The insulating protective layer includes a cover part containing a cured product of polysilsesquioxane. The cover part includes a surface cover layer covering a surface of the element part and a filling part filled in the trimming groove.

According to the present disclosure, hygroscopicity of the insulating protective layer can be reduced with the cover part containing polysilsesquioxane, and the element part is less likely to be affected by moisture. Thus, an electronic component having a small change in characteristics due to moisture can be provided.

### BRIEF DESCRIPTION OF THE DRAWINGS

FIG. 1 is a sectional view illustrating an electronic component (chip resistor) according to a first exemplary embodiment.

FIG. 2A is an explanatory view illustrating one step for producing the electronic component (chip resistor) according to the first exemplary embodiment.

FIG. 2B is an explanatory view illustrating one step for producing the electronic component (chip resistor) according to the first exemplary embodiment.

FIG. 2C is an explanatory view illustrating one step for producing the electronic component (chip resistor) according to the first exemplary embodiment.

FIG. 3A is an explanatory view illustrating one step for producing the electronic component (chip resistor) according to the first exemplary embodiment.

FIG. 3B is an explanatory view illustrating one step for producing the electronic component (chip resistor) according to the first exemplary embodiment.

FIG. 3C is an explanatory view illustrating one step for producing the electronic component (chip resistor) according to the first exemplary embodiment.

FIG. 3D is an explanatory view illustrating one step for producing the electronic component (chip resistor) according to the first exemplary embodiment.

FIG. 3E is an explanatory view illustrating one step for producing the electronic component (chip resistor) according to the first exemplary embodiment.

FIG. 3F is an explanatory view illustrating one step for producing the electronic component (chip resistor) according to the first exemplary embodiment.

FIG. 3G is an explanatory view illustrating one step for producing the electronic component (chip resistor) according to the first exemplary embodiment.

FIG. 3H is an explanatory view illustrating one step for producing the electronic component (chip resistor) according to the first exemplary embodiment.

FIG. 4 is a sectional view illustrating an electronic component (chip resistor) according to a second exemplary embodiment.

FIG. 5 is a sectional view illustrating an electronic component (chip resistor) according to Comparative Example.

FIG. 6A is a graph showing the test time and the resistance value change rate in a humidity resistance test of Reference Example.

FIG. 6B is a graph showing the test time and the resistance value change rate in a humidity resistance test of Reference Example.

FIG. 6C is a graph showing the test time and the resistance value change rate in a humidity resistance test of Reference Example.

FIG. 7A is a graph showing the test time and the resistance value change rate in a humidity resistance test of Comparative Example including insulating protective layers having different water absorption rates.

FIG. 7B is a graph showing the test time and the resistance value change rate in a humidity resistance test of Comparative Example including insulating protective layers having different water absorption rates.

FIG. 7C is a graph showing the test time and the resistance value change rate in a humidity resistance test of Comparative Example including insulating protective layers having different water absorption rates.

FIG. 8A is a graph showing the test time and the resistance value change rate in a humidity resistance test of Example 2.

FIG. 8B is a graph showing the test time and the resistance value change rate in a humidity resistance test of Comparative Example.

### DESCRIPTION OF EMBODIMENT

Hereinafter, an electronic component according to an exemplary embodiment will be described below reference to the drawings. The following exemplary embodiment is merely one of various exemplary embodiments of the present disclosure. The following exemplary embodiment can be variously changed in accordance with factors such as a design, as long as the object of the present disclosure can be achieved. The drawings described in the following exemplary embodiment are schematic representations, and ratios of sizes and thicknesses of components in the drawings do not necessarily need to reflect actual dimensional ratio.

Although arrows defining the X axis, the Y axis, and the Z axis are illustrated in the drawing, these arrows are merely illustrated for convenience of description, are not intended to limit the direction of the electronic component, and are not associated with entity. The X axis, the Y axis, and the Z axis are orthogonal to each other.

In the following description, a “plane direction” means an “XY plane direction”, a “thickness direction” means a “Z-axis direction”, a “plane view” means viewing along the Z-axis direction, and a “front view” means viewing along the X-axis direction. The Y-axis direction may be rephrased as a left-right direction, and the Z-axis direction may be rephrased as an up-down direction.

### First Exemplary Embodiment

### (1) Overview

An electronic component of the present exemplary embodiment is a chip resistor. The chip resistor is, for example, a surface mount (SMT) chip resistor mounted on a surface (mounting surface) of a printed circuit board using a surface mount machine (mounter). The chip resistor is, for example, a thick film chip resistor.

In such a chip resistor, to adjust the resistance value, cutting of a part of the resistor body with a laser or the like, that is, so-called laser trimming, is performed. Thus, a trimming groove is formed in the resistor body after laser trimming.

The resistor body is covered with an insulating protective layer. The insulating protective layer includes a resin layer and a glass film. The glass film is provided on a surface of the resistor body (the surface not facing the substrate) in a portion other than the trimming groove. The resin layer is provided on a surface of the glass film (precoated glass) (the surface not facing the substrate). The resin layer is also filled in the trimming groove.

Covering the resistor body with the insulating protective layer in this manner causes moisture to hardly reach the resistor body and reduces a change in the resistance value of the resistor body due to moisture. However, since the resin layer is likely to absorb moisture, moisture (wet) may reach the trimming groove through the resin layer. Thus, in such an electronic component, in the moisture absorption test, moisture may reach the trimming groove because of the resin layer absorbing moisture, and the resistance value may change.

The resin of the resin layer filled in the trimming groove has a small effect of reducing the hygroscopicity. Thus, it is conceivable to fill the trimming groove with a part of the glass film having lower hygroscopicity than the resin layer. In this case, the trimming groove has to be coated again with precoated glass to form a glass film. Thus, it is necessary to cure the precoated glass coated again at a high temperature, and the resistance value adjusted through trimming may change because of this high temperature.

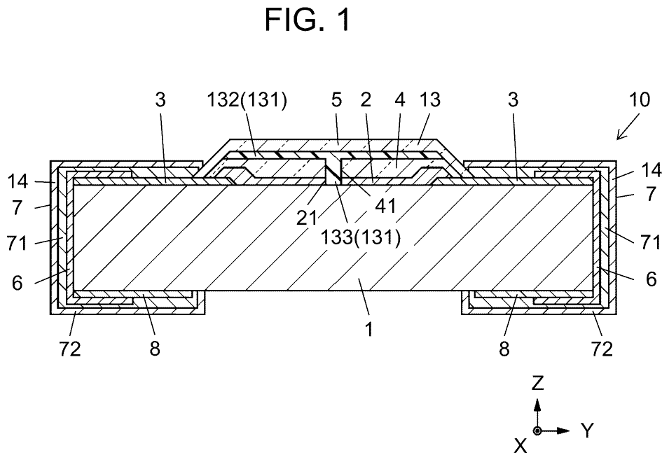

Thus, the inventors of the present invention have reached an invention in which a resistor body is protected by an insulating protective layer using polysilsesquioxane. The invention is illustrated in FIG. 1. FIG. 1 is a sectional view illustrating electronic component (chip resistor) 10 according to a first exemplary embodiment.

That is, the chip resistor which is electronic component 10 of the present exemplary embodiment includes substrate 1, element part 2, and insulating protective layer 13. Element part 2 is a resistor body and is formed on substrate 1. Insulating protective layer 13 covers element part 2. Element part 2 includes trimming groove 21. Insulating protective layer 13 includes cover part 131 containing polysilsesquioxane. Cover part 131 includes surface cover layer 132 covering the surface of element part 2 and filling part 133 filled in trimming groove 21.

According to the present exemplary embodiment, cover part 131 contains polysilsesquioxane. Thus, the hygroscopicity of cover part 131 is small as that of glass such as a glass film. Therefore, moisture is less likely to reach the resistor body (element part 2) because of cover part 131, and a change in the resistance value of the chip resistor due to moisture can be reduced. In addition, polysilsesquioxane can be handled as a liquid coating agent like a resin, and can be cured at 150° C. to 200° C. Thus, when the coating agent is cured, the resistor body is hardly exposed to a high temperature, and the resistance value of the chip resistor is hardly changed by the high temperature. Therefore, electronic component 10 of the present exemplary embodiment can be formed as a chip resistor having a small change in resistance value in a moisture absorption test.

### (2) Details

### (2.1) Structure of Electronic Component

As illustrated in FIG. 1, a chip resistor which is electronic component 10 of the present exemplary embodiment includes substrate 1, element part 2, and insulating protective layer 13. Electronic component 10 further includes extraction electrode 3 and external electrode 14.

Substrate 1 is an alumina substrate having electrical insulation properties and containing, for example, 96% to 99% of Al₂O₃ (alumina). The shape of substrate 1 in plane view (as viewed from above in the Z-axis direction in FIG. 1) is, for example, a rectangular shape such as a rectangle.

Element part 2 is a resistor body, has electrical resistance, is a thick film, and is provided on one surface (upper surface in FIG. 1) of substrate 1. Element part 2 is made of, for example, RuO₂, AgPd, CuNi, or the like. Element part 2 is positioned at a substantially central part of substrate 1 in plane view, and has a rectangular shape such as a rectangle in plane view.

Element part 2 includes trimming groove 21. Trimming groove 21 is formed by removing a part of element part 2 with a laser or the like. The bottom surface of trimming groove 21 is formed of the upper surface of substrate 1. A side surface of trimming groove 21 is formed of a surface facing trimming groove 21 of element part 2. Trimming groove 21 is formed to adjust the resistance value of element part 2. The trimming groove can reduce the variation in the resistance value for each electronic component 10. The length, width, and shape of the trimming groove 21 vary depending on the target resistance value.

Extraction electrode 3 is an upper-surface electrode, and a pair of extraction electrodes is provided on the upper surface of substrate 1. Extraction electrodes 3 are electrically connected to element part 2 at both end portions in the left-right direction (Y-axis direction in FIG. 1) of element part 2. Specifically, one end portion of each extraction electrode 3 is positioned below element part 2, and the other end portion of each extraction electrode 3 is positioned at the right end or the left end of substrate 1.

Extraction electrode 3 contains silver of metal. Extraction electrode 3 may contain a metal such as copper, gold, nickel, tin, or palladium. Extraction electrode 3 is formed of, for example, a cured product of a conductive paste. The conductive paste contains, for example, a resin component or a glass component and conductor particles. The conductor particles can be formed of particles containing the metal. Extraction electrode 3 is made of, for example, an Ag-based cermet thick film electrode.

Insulating protective layer 13 is a layer for protecting element part 2 by making gas such as a sulfide gas and wet (moisture) less likely to come into contact with element part 2. Insulating protective layer 13 is also a layer having electrical insulation properties, securing the electrical insulation properties of element part 2.

Insulating protective layer 13 covers entire element part 2. That is, insulating protective layer 13 covers the surface of element part 2 other than the surface facing substrate 1. Insulating protective layer 13 covers a part of extraction electrode 3. Here, a part of extraction electrode 3 is an end portion of extraction electrode 3 connected to element part 2 and a peripheral part thereof. This protects the connecting part between element part 2 and extraction electrode 3 with insulating protective layer 13, makes gas and moisture hardly act on the connecting part between the element part 2 and the extraction electrode 3, and makes corrosion hardly occur.

Insulating protective layer 13 includes glass film (precoated glass) 4, resin layer 5, and cover part 131.

Glass film 4 is formed on the surface of element part 2 and covers entire element part 2. Glass film 4 covers a part of extraction electrode 3 at both end portions of substrate 1 in the Y-axis direction (left-right direction in FIG. 1). That is, glass film 4 covers the connecting part between element part 2 and each extraction electrode 3 as viewed from the Z-axis direction (film thickness direction) of element part 2.

Glass film 4 includes through hole 41. Through hole 41 is positioned above trimming groove 21 and communicates with trimming groove 21. Through hole 41 is simultaneously formed by laser trimming when trimming groove 21 is formed. That is, through hole 41 is formed by cutting a part of glass film 4 with a laser or the like. Thus, the shape of through hole 41 in plane view is the same as the plane shape of trimming groove 21, and through hole 41 and trimming groove 21 overlap each other in plane view.

Glass film 4 is made of an inorganic material, for example, a glass material such as crystal glass or quartz glass, an inorganic material containing Al₂O₃ (alumina), or the like. Glass film 4 may be made of a metal oxide other than alumina or a metal nitride.

Cover part 131 contains a cured product of polysilsesquioxane. Polysilsesquioxane is obtained by hydrolyzing a trifunctional silane, and is a network type polymer or polyhedral cluster having a structure of (RSiO_{1.5})ₙ. Each silicon atom is bound to an average of 1.5 (Sesqui) oxygen atoms and 1 hydrocarbon group. Thus, polysilsesquioxane is an inorganic compound having a cage-like skeleton formed of up to 8 organic functional groups and Si—O bonds. Polysilsesquioxane is a stoichiometric compound of an intermediate between silica (SiO₂) and silicone (R₂SiO), that is, silsesquioxane (RSiO_{1.5}), and is a nanomaterial having a property of an inorganic substance having affinity for an organic substance. Thus, polysilsesquioxane may be referred to as an organic-inorganic hybrid material.

As the polysilsesquioxane in the present exemplary embodiment, for example, polysilsesquioxanes having the following structural formulas (A), (B), and (C) are used.

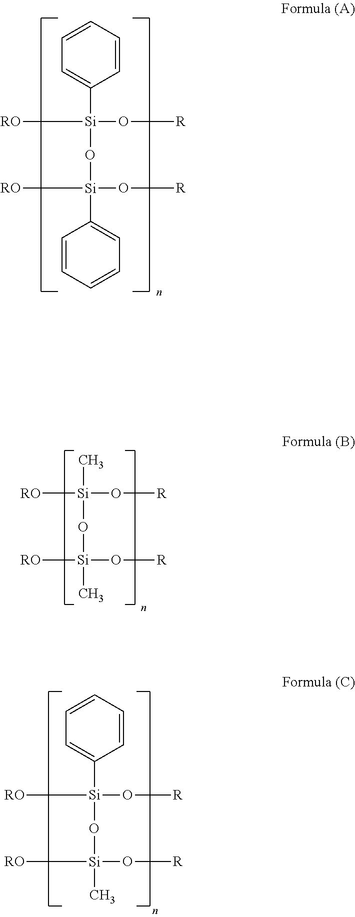

In Formulas (A), (B), and (C), R is H (hydrogen atom) or an alkyl group such as a methyl group or an ethyl group. n is an integer of 5 to 50. n may be the same value or different values among Formula (A), Formula (B), and Formula (C). n is preferably such a value that the weight-average molecular weight (Mw) of the polysilsesquioxane falls within the range from 500 to 10,000.

The polysilsesquioxane reacts and cures. The outline of the curing reaction of the polysilsesquioxane is represented by, for example, the following Formula (D) or Formula (E).

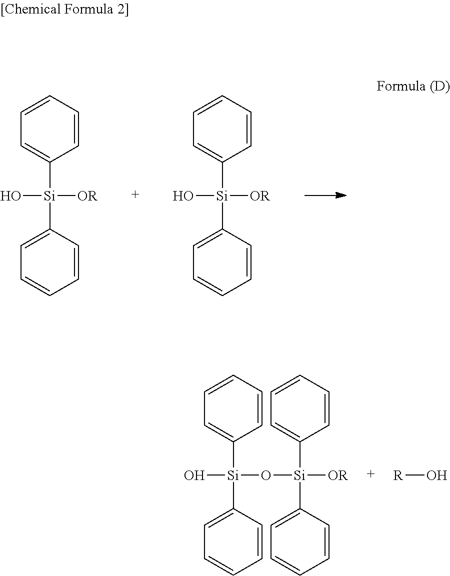

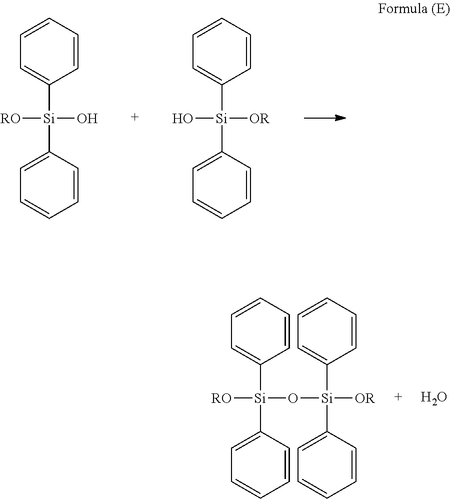

In the present exemplary embodiment, cover part 131 can contain a cured product of the polysilsesquioxane of Formula (A), a cured product of the polysilsesquioxane of Formula (B), or a cured product of the polysilsesquioxane of Formula (C).

Cover part 131 may contain two or more of a cured product of the polysilsesquioxane of Formula (A), a cured product of the polysilsesquioxane of Formula (B), and a cured product of the polysilsesquioxane of Formula (C).

Cover part 131 may also contain a cured product obtained by reacting the polysilsesquioxane of Formula (A) with the polysilsesquioxane of Formula (B), a cured product obtained by reacting the polysilsesquioxane of Formula (A) with the polysilsesquioxane of Formula (C), or a cured product obtained by reacting the polysilsesquioxane of Formula (B) with the polysilsesquioxane of Formula (C). Cover part 131 may further contain a cured product obtained by reacting three types of polysilsesquioxanes of Formula (A), Formula (B), and Formula (C).

In the present exemplary embodiment, the weight-average molecular weight (Mw) of the polysilsesquioxane is preferably 500 to 10,000. With the weight-average molecular weight in this range, when cover part 131 is formed with the coating agent containing polysilsesquioxane, the coating agent is not excessively high or low in viscosity, and is easily applied.

In the present exemplary embodiment, a terminal group of the polysilsesquioxane preferably contains an ethoxy group. That is, the terminal group of the polysilsesquioxane may contain a hydroxy group or a methoxy group, but the proportion of the ethoxy group is preferably large to improve the adhesion of cover part 131 to glass film 4 and element part 2 or to improve the curability of the polysilsesquioxane. All of the terminal groups of the polysilsesquioxane may be ethoxy groups.

In the present exemplary embodiment, the polysilsesquioxane preferably has at least one of a phenyl group and a methyl group in the basic skeleton. That is, as the polysilsesquioxane, one having only a phenyl group as a functional group (one represented by Formula (A)), one having only a methyl group (one represented by Formula (B)), and one having both a phenyl group and a methyl group (one represented by Formula (C)) can be used. In the cured product of polysilsesquioxane, when the proportion of the phenyl group in the functional group increases, the rigidity tends to increase and the cured product tends to be hard. Thus, it is preferable to adjust the proportion of the phenyl group and the methyl group in the functional group so that cover part 131 is less likely to be cracked.

As the polysilsesquioxane, a material having an ethoxy group at a terminal, a phenyl group as a functional group, and a weight-average molecular weight of 750 (for example, SR-23 manufactured by KONISHI CHEMICAL IND. CO., LTD.) may be used. As the polysilsesquioxane, a material having an ethoxy group at a terminal, a methyl group as a functional group, and a weight-average molecular weight of 4000 (for example, SR-13 manufactured by KONISHI CHEMICAL IND. CO., LTD.) may be used. As the polysilsesquioxane, a material having an ethoxy group at a terminal, both a methyl group and a phenyl group as functional groups, and a weight-average molecular weight of 5000 (for example, SR-33 manufactured by KONISHI CHEMICAL IND. CO., LTD.) may be used.

Cover part 131 preferably contains a cured product of polysilsesquioxane and an inorganic filler. In this case, as compared with the case where cover part 131 contains only a cured product of polysilsesquioxane, the linear expansion coefficient of cover part 131 is easily adapted to the linear expansion coefficients of glass film 4 and element part 2, and cover part 131 is hardly peeled off from glass film 4 and element part 2 due to thermal deformation.

Examples of the inorganic filler include silica, alumina, talc, kaolin, mica, barium sulfate, and calcium carbonate. One of these may be used, or a mixture of two or more thereof may be used.

Cover part 131 preferably contains the cured product of polysilsesquioxane in an amount of from 10 mass % to 50 mass % inclusive and the inorganic filler in an amount of from 50 mass % to 90 mass % inclusive. With the content within such a range, when coating part 131 is formed with a coating agent containing polysilsesquioxane, the coating agent is not excessively high or low in viscosity, and is easily applied. In addition, when the content is within the above range, the shape of cover part 131 is easily maintained, the shape retainability is excellent, and the production becomes easy. When the content is within the above range, the linear expansion coefficient of cover part 131 is easily adapted to the linear expansion coefficients of glass film 4 and element part 2, and cover part 131 is hardly peeled off from glass film 4 and element part 2 due to thermal deformation. Cover part 131 preferably contains only polysilsesquioxane as a component that reacts and cures.

Cover part 131 includes surface cover layer 132 and filling part 133. Surface cover layer 132 is formed on the surface of glass film 4. Surface cover layer 132 faces the upper surface of element part 2 over substantially the entire surface with glass film 4 interposed therebetween. The end portion of surface cover layer 132 is positioned above the connecting part between the end portion of element part 2 and the end portion of extraction electrode 3. As a result, surface cover layer 132 covers almost the entire surface of element part 2.

Filling part 133 protrudes downward from surface cover layer 132 and is positioned and filled in through hole 41. A tip (lower end) of filling part 133 is positioned and filled in trimming groove 21.

In the present exemplary embodiment, by providing surface cover layer 132 containing a cured product of polysilsesquioxane which is an organic-inorganic hybrid material on the surface of glass film 4, the surface of element part 2 is covered, and thus the amount of moisture reaching element part 2 through glass film 4 can be reduced. Thus, the influence of moisture on element part 2 can be reduced, and the change in the resistance value of element part 2 due to moisture can be reduced.

In the present exemplary embodiment, the thickness of surface cover layer 132 is preferably from 1 μm to 30 μm inclusive. In this case, moisture hardly reaches glass film 4 through surface cover layer 132, and insulating protective layer 13 having sufficient moisture resistance is likely to be obtained.

In the present exemplary embodiment, since filling part 133 containing a cured product of polysilsesquioxane which is an organic-inorganic hybrid material is filled in trimming groove 21, the amount of moisture reaching the inside of element part 2 through trimming groove 21 can be reduced. Thus, the influence of moisture on element part 2 can be reduced, and the change in the resistance value of element part 2 due to moisture can be reduced.

Resin layer 5 is formed on the surfaces of surface cover layer 132 and glass film 4, and entirely covers surface cover layer 132 and glass film 4. Thus, resin layer 5 covers entire element part 2 with surface cover layer 132 and glass film 4 interposed therebetween.

Resin layer 5 is a layer for protecting surface cover layer 132, glass film 4, and element part 2. Resin layer 5 is formed of a cured product of a coating agent containing an epoxy resin. Resin layer 5 is formed on the surfaces of surface cover layer 132 and glass film 4, and covers a part of the pair of extraction electrodes 3. That is, resin layer 5 covers the boundary between glass film 4 and the pair of extraction electrodes 3 and continuously covers at least a part of the pair of extraction electrodes 3 from glass film 4 when viewed from the film thickness direction of element part 2. Thus, resin layer 5 covers element part 2. The shape of resin layer 5 in plane view is, for example, a rectangular shape such as a rectangle. Of the pair of extraction electrodes 3, a portion positioned between both end portions in the longitudinal direction (Y-axis direction in FIG. 1) of glass film 4 and metal plating layer 7 is directly covered with resin layer 5.

Resin layer 5 may contain silica particles and silicone rubber particles in addition to the resin. In this case, stress generated in resin layer 5 due to heat or the like can be alleviated as compared with a case where resin layer 5 is formed of a resin alone. Thus, the thermal expansion and contraction of resin layer 5 easily follows the thermal expansion and contraction of glass film 4 and surface cover layer 132, and resin layer 5, glass film 4, and surface cover layer 132 are hardly peeled off.

Electronic component 10 further includes a pair of back face electrodes 8. Each of the pair of back face electrodes 8 is provided on the lower surface of substrate 1 (surface without element part 2 or extraction electrode 3). Each of the pair of back face electrodes 8 is made of, for example, an Ag-based cermet thick film electrode. The pair of back face electrodes 8 is positioned at both end portions in the longitudinal direction (left-right direction in FIG. 1) of the back face (lower surface in FIG. 1) of substrate 1. The pair of back face electrodes 8 has a one-to-one correspondence with the pair of extraction electrodes 3. The pair of back face electrodes 8 may be omitted.

External electrode 14 is a portion used as a terminal for electrical connection with a device when electronic component 10 is mounted on the device. External electrode 14 includes a pair of electrode layers (end-face electrodes) 6 and a pair of metal plating layers 7. Each of the pair of electrode layers 6 is made of, for example, a metal layer containing a metal such as Ag. The pair of electrode layers 6 is positioned at both end portions in the longitudinal direction (left-right direction in FIG. 1) of substrate 1. The pair of electrode layers 6 is electrically connected to the pair of extraction electrodes 3 and the pair of back face electrodes 8. The pair of electrode layers 6 is provided in contact with the surfaces of the end portions of extraction electrode 3 and back face electrode 8 on the side opposite to the end portion on element part 2 side. Thus, each of the pair of electrode layers 6 covers corresponding one of the pair of back face electrodes 8.

Each electrode layer 6 is preferably formed of, for example, a conductor containing a resin component, carbon particles, and silver powder. In this case, the resin component is a phenoxy resin, an epoxy resin, or the like. The carbon particles are blended for the purpose of assisting the conductivity of electrode layer 6. When electrode layer 6 is formed of a cured product of a conductive paste, carbon particles are blended as a colorant for application recognition of the conductive paste. As the silver powder, a whisker-like inorganic filler whose surface is covered with a silver conductive film, and a flake-like silver powder can be used. The whisker-like inorganic filler can improve the flexural strength of electrode layer 6. The flake-like silver powder can improve adhesion between electrode layer 6 and metal plating layer 7. Electrode layer 6 may be a conductor formed by metal sputtering such as a nickel-chromium alloy.

Each of the pair of metal plating layers 7 includes first plating layer 71 and second plating layer 72. Each of the pair of metal plating layers 7 is connected to a part of corresponding extraction electrode 3 in the pair of extraction electrodes 3, and is in contact with the surface of resin layer 5 of insulating protective layer 13. Each of the pair of metal plating layers 7 covers corresponding electrode layer 6 of the pair of electrode layers 6. First plating layer 71 can be formed by, for example, Ni plating. The second plating layer 72 can be formed by, for example, Sn plating.

External electrode 14 covers a part of insulating protective layer 13. Here, a part of insulating protective layer 13 is an end portion of insulating protective layer 13, in which an end portion of extraction electrode 3 on element part 2 side is covered with the end portion of insulating protective layer 13. Thus, covering the end portion of insulating protective layer 13 with external electrode 14 can cover the boundary between insulating protective layer 13 and extraction electrode 3 with external electrode 14, and gas and moisture hardly enter extraction electrode 3.

### (2.2) Method for Producing Electronic Component

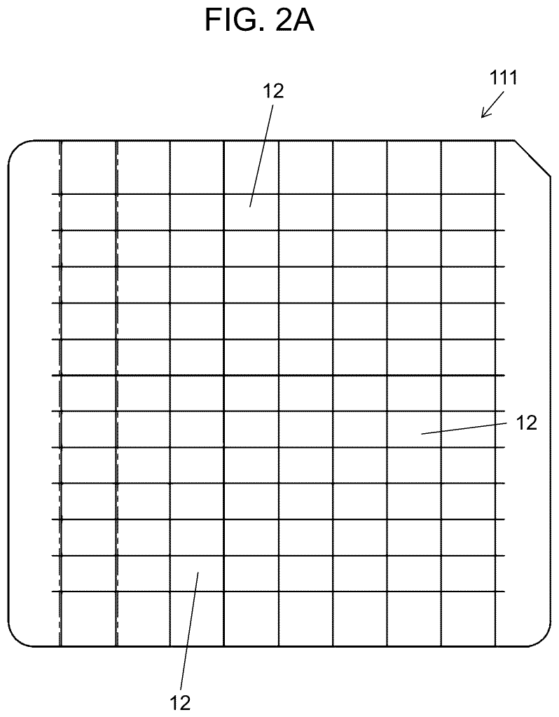

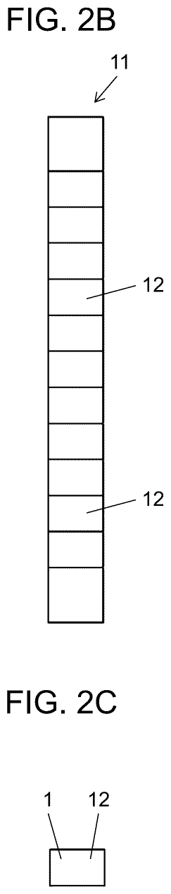

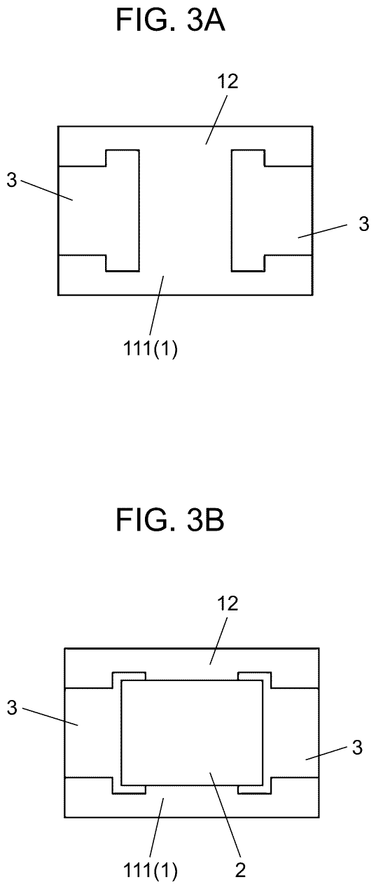

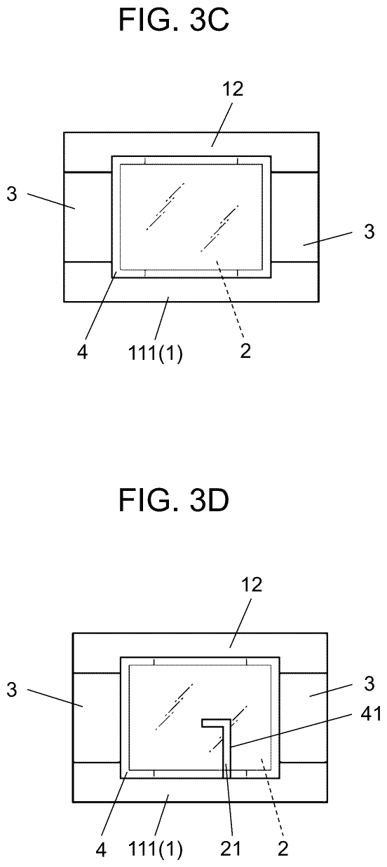

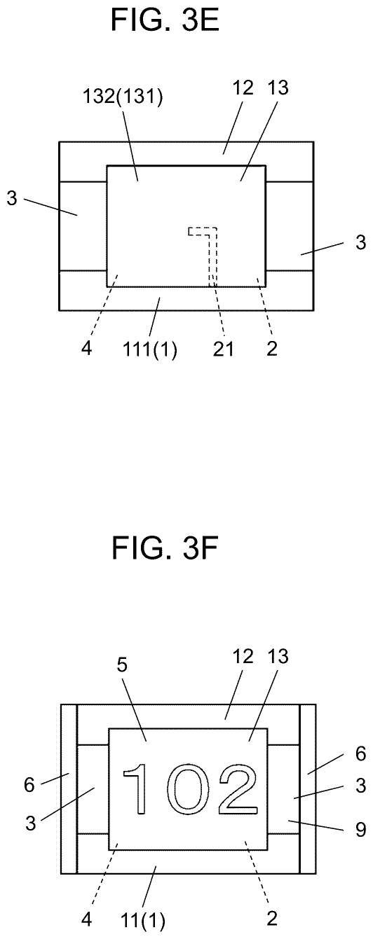

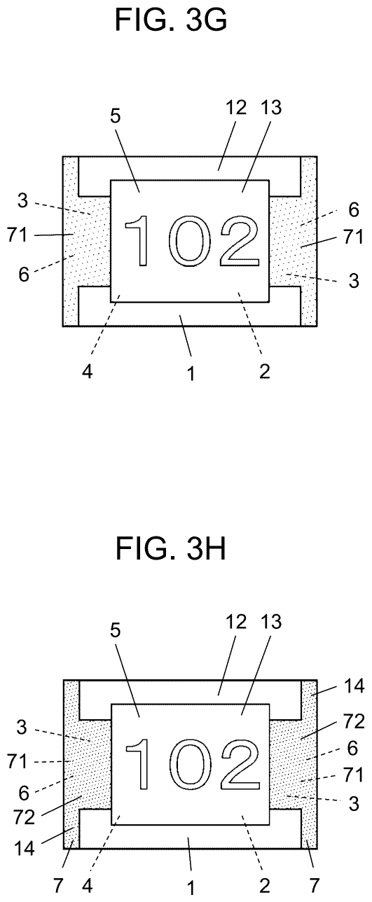

A method for producing electronic component 10 according to the present exemplary embodiment will be described based on FIGS. 2A to 2C and FIGS. 3A to 3H. FIGS. 2A to 2C are explanatory views illustrating steps for producing electronic component 10 according to the present exemplary embodiment. More specifically, FIGS. 2A to 2C are diagrams illustrating a series of steps for forming substrate 1 including one chip region 12 from sheet-shaped substrate 111. FIGS. 3A to 3H are explanatory views illustrating steps for producing electronic component 10 according to the present exemplary embodiment. More specifically, FIGS. 3A to 3H are views illustrating a series of steps for providing extraction electrode 3 on a front face of each chip region 12 of sheet-shaped substrate 111 to form electronic component 10.

In forming electronic component 10, as illustrated in FIG. 2A, sheet-shaped substrate 111 is used. Sheet-shaped substrate 111 is formed in a substantially rectangular shape in plane view, and is formed of the same material with the same thickness as substrate 1. Sheet-shaped substrate 111 is formed larger than substrate 1, from which a plurality of substrates 1 can be taken. A plurality of chip regions 12 having the same size as substrate 1 is formed on sheet-shaped substrate 111. Each chip region 12 corresponds to one substrate 1. That is, one electronic component 10 is produced by forming element part 2, insulating protective layer 13, and the like in each chip region 12. The plurality of chip regions 12 are provided side by side in a longitudinal direction and a lateral direction on sheet-shaped substrate 111. As will be described later, after resin layer 5 is formed, sheet-shaped substrate 111 is divided into strip-shaped substrate 11 in which a plurality of chip regions 12 are connected in the longitudinal direction as illustrated in FIG. 2B. After electrode layer 6 is formed as described later, strip-shaped substrate 11 is divided in the lateral direction to form substrate 1 having one chip region 12 as illustrated in FIG. 2C.

Then, first, a back face electrode (not illustrated in FIGS. 2A to 2C and FIGS. 3A to 3H) is formed on the back face of each chip region 12 of sheet-shaped substrate 111. Next, extraction electrode 3 is formed on the front face of each chip region 12 of sheet-shaped substrate 111 (see FIG. 3A). For extraction electrode 3 and the back face electrode, for example, an Ag-based cermet conductive paste can be used. Extraction electrode 3 and the back face electrode are formed by, for example, printing (applying) a conductive paste on both end portions in the longitudinal direction of the front face and the back face of chip region 12 by screen printing, and then sintering the conductive paste. Extraction electrode 3 and the back face electrode may also be formed by forming a metal film at both end portions in the longitudinal direction of the front face and the back face of chip region 12 by sputtering, and then removing unnecessary portions of the film by photolithography and etching.

After extraction electrode 3 is formed, element part 2 is formed on the front face of each chip region 12 of sheet-shaped substrate 111 (see FIG. 3B). Element part 2 is formed, for example, by printing (applying) a resistor body paste made of RuO₂ on the front face of chip region 12 by screen printing and then firing the resistor body paste.

After element part 2 is formed, glass film 4 covering the surface of element part 2 is formed (see FIG. 3C). Glass film 4 is formed, for example, by printing (applying) a glass coating agent on each chip region 12 by screen printing and then firing the glass coating agent.

After glass film 4 is formed, trimming is performed (see FIG. 3D). The trimming is performed to adjust the resistance value of electronic component 10. The trimming is performed by removing a part of element part 2 and glass film 4 of each chip region 12 with a laser or the like to form trimming groove 21.

After the trimming, cover part 131 is formed (see FIG. 3E). Cover part 131 is formed by printing (coating) a coating agent containing a polysilsesquioxane, an inorganic filler, and a solvent on chip region 12 by screen printing, then drying the coating agent by heating or the like, and curing the polysilsesquioxane by heating or the like. When the coating agent is printed on the surface of glass film 4, the coating agent reaches trimming groove 21 through hole 41 and is filled in through hole 41 and trimming groove 21. The polysilsesquioxane is cured at a temperature (about 150 to 200° C.) lower than the firing temperature (more than or equal to 600° C.) of glass film 4. Thus, cover part 131 can be formed at a temperature lower than the firing temperature of glass film 4.

After the formation of cover part 131, resin layer 5 cover the surface of surface cover layer 132 is formed (see FIG. 3F). Resin layer 5 is formed, for example, by printing (applying) a coating agent described later on chip region 12 by screen printing and then curing the coating agent by heating or the like. A display unit is formed on the surface of resin layer 5. In FIG. 3F, characters “102” are formed on the display unit. The display unit indicates the resistance value, the product number, the type, and the like of electronic component 10. The display unit is formed by, for example, printing ink on the surface of resin layer 5 with a seal or the like, and then curing the ink with heat, ultraviolet light, or the like.

After resin layer 5 is formed, sheet-shaped substrate 111 is divided into elongated strips (primary division) to form strip-shaped substrate 11 as illustrated in FIG. 2B. A division position of sheet-shaped substrate 111 is indicated by a dashed line in FIG. 2A. Sheet-shaped substrate 111 is divided at positions of both end portions in the longitudinal direction of chip region 12. As a result, a plurality of chip regions 12 are arranged along the longitudinal direction of strip-shaped substrate 11. Extraction electrodes 3 formed in respective chip regions 12 are arranged along the longitudinal direction of strip-shaped substrate 11.

Next, electrode layer 6 is formed in each chip region 12 (see FIG. 3F). Electrode layer 6 is formed at an end portion in the longitudinal direction of strip-shaped substrate 11. Electrode layer 6 is formed by, for example, printing (applying) and curing a conductive paste or the like. Electrode layer 6 may also be formed by sputtering, for example.

After electrode layer 6 is formed, strip-shaped substrate 11 is divided so as to be divided into individual pieces in each chip region 12 (secondary division) to form substrate 1 as illustrated in FIG. 2C. Thereafter, first plating layer 71 and second plating layer 72 constituting metal plating layer 7 are sequentially formed (see FIGS. 3G and 3H). Electronic component 10 is thus formed. Electronic component 10 is shipped after completion inspection and taping.

### (3) Modifications

The first exemplary embodiment is merely one of various exemplary embodiments of the present disclosure. The first exemplary embodiment can be variously changed in accordance with design and the like, as long as the object of the present disclosure can be achieved.

In the above description, a case where electronic component 10 is a chip resistor has been described, but the electronic component is not limited to this configuration. Electronic component 10 may be a capacitor, a semiconductor device, or the like.

### Second Exemplary Embodiment

Electronic component 10 according to the present exemplary embodiment is different from electronic component 10 according to the first exemplary embodiment in the configuration of insulating protective layer 13. Hereinafter, the same configurations as those of the first exemplary embodiment are denoted by the same reference numerals, and the description thereof will be appropriately omitted. The configuration described in the second exemplary embodiment is applicable by being combined with the configurations (including modifications) described in the first exemplary embodiment.

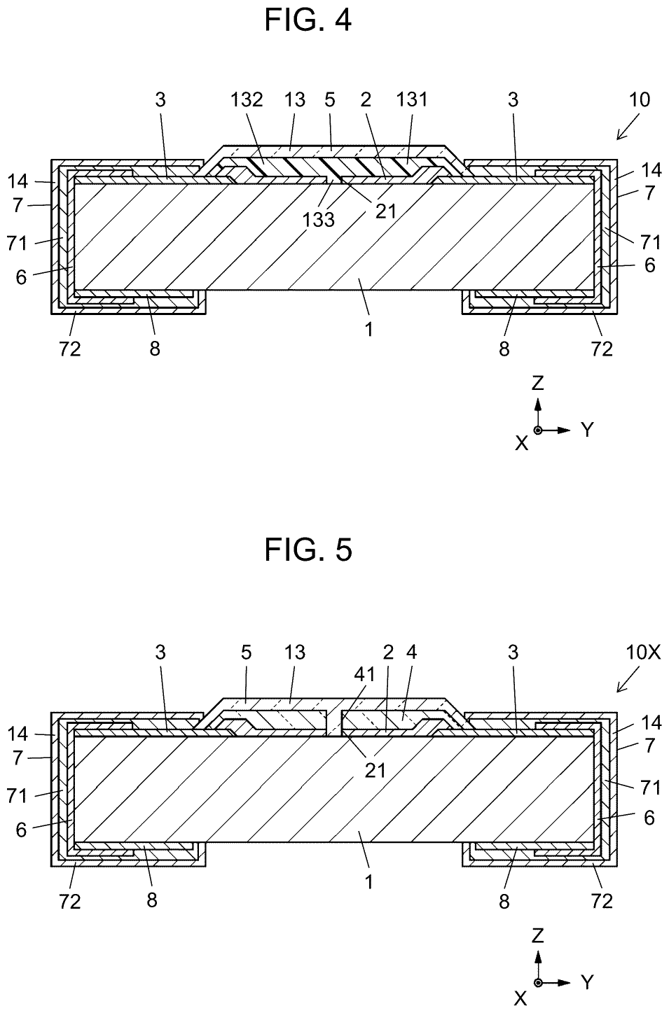

FIG. 4 is a sectional view illustrating electronic component 10 of the present exemplary embodiment. As illustrated in FIG. 4, in the present exemplary embodiment, insulating protective layer 13 includes cover part 131 and resin layer 5. That is, in the present exemplary embodiment, insulating protective layer 13 does not include glass film 4, but includes cover part 131 and resin layer 5.

Cover part 131 includes surface cover layer 132 covering the surface of element part 2 and filling part 133 filled in trimming groove 21. Surface cover layer 132 is formed on the surface of element part 2 and covers the entire surface of element part 2. Surface cover layer 132 covers a part of extraction electrode 3 at both end portions in the Y-axis direction (left-right direction in FIG. 4) of substrate 1. That is, surface cover layer 132 covers the connecting part between element part 2 and each extraction electrode 3 as viewed from the Z-axis direction (film thickness direction) of element part 2. Resin layer 5 is formed over the entire surface of surface cover layer 132.

In the present exemplary embodiment, insulating protective layer 13 does not include glass film 4, but instead, element part 2 is covered with cover part 131 containing polysilsesquioxane. Thus, the high firing temperature at the time of forming glass film 4 does not act on element part 2, which reduces the change in the resistance value of element part 2 due to the heat.

### Conclusions

As described above, electronic component (10) according to a first aspect includes substrate (1), element part (2), and insulating protective layer (13). Element part (2) is formed on substrate (1). Insulating protective layer (13) covers element part (2). Element part (2) includes trimming groove (21). Insulating protective layer (13) includes cover part (131) containing a cured product of polysilsesquioxane. Cover part (131) includes surface cover layer (132) covering a surface of element part (2) and filling part (133) filled in trimming groove (21).

According to this aspect, the hygroscopicity of insulating protective layer (13) can be reduced with cover part (131) containing a cured product of polysilsesquioxane, and element part (2) is less likely to be affected by moisture. Thus, the change in characteristics due to moisture is small.

A second aspect is electronic component (10) according to the first aspect, in which cover part (131) contains the cured product of polysilsesquioxane in an amount of from 10 mass % to 50 mass % inclusive and an inorganic filler in an amount of from 50 mass % to 90 mass % inclusive.

According to this aspect, the shape retainability of cover part (131) is excellent, and the production is easy.

A third aspect is electronic component (10) according to the first or second aspect, in which surface cover layer (132) has a thickness of from 1 μm to 30 μm inclusive.

According to this aspect, element part (2) is less likely to be affected by moisture, and the change in characteristics due to moisture is small.

A fourth aspect is electronic component (10) according to any one of the first to third aspects, in which a terminal group of the polysilsesquioxane contains an ethoxy group.

According to this aspect, the adhesion of cover part (131) to element part (2) or a glassy member is excellent.

A fifth aspect is electronic component (10) according to any one of the first to fourth aspects, in which the polysilsesquioxane includes at least one of a phenyl group and a methyl group in a skeleton.

According to this aspect, cracks are less likely to occur in cover part (131).

A sixth aspect is electronic component (10) according to any one of the first to fifth aspects, in which cover part (131) covers an entire upper portion of element part (2) in plane view of element part (2).

According to this aspect, the influence of moisture on element part (2) can be further reduced, and the change in characteristic changes due to moisture is small.

A seventh aspect is electronic component (10) according to any one of the first to sixth aspects, in which insulating protective layer (13) further includes glass film (4) provided on a surface of element part (2). Surface cover layer (132) is provided on a surface of glass film (4). Filling part (133) penetrates glass film (4) and is filled in trimming groove (21).

According to this aspect, the hygroscopicity of insulating protective layer (13) can be reduced by glass film (4), element part (2) is less likely to be affected by moisture, and the change in characteristics due to moisture is small.

An eighth aspect is electronic component (10) according to any one of the first to sixth aspects, in which insulating protective layer (13) further includes resin layer (5) provided on a surface of surface cover layer (132). Surface cover layer (132) is provided on a surface of element part (2).

According to this aspect, the hygroscopicity of insulating protective layer (13) can be reduced by cover part (131) containing polysilsesquioxane, element part (2) is less likely to be affected by moisture, and the change in characteristics due to moisture is small.

### EXAMPLES

### Example 1

The square chip resistor (electronic component 10) illustrated in FIG. 1 was made according to the steps illustrated in FIGS. 2A to 2C and FIGS. 3A to 3H. In this electronic component, a resistor body (element part 2) containing RuO₂ and the like was formed on a surface of an alumina substrate (substrate 1) under firing conditions of 850° C./10 minutes. Next, an Ag-based cermet thick film electrode (extraction electrode 3) was formed under firing conditions of 850° C./10 minutes. Next, precoated glass (glass film 4) was formed under firing conditions of 600° C./50 minutes. Next, cover part 131 was formed by using a coating agent containing polysilsesquioxane. Next, an epoxy resin layer (resin layer 5) was formed under curing conditions of 200° C./10 minutes.

As the polysilsesquioxane, a material having an ethoxy group at a terminal, a phenyl group as a functional group, and a weight-average molecular weight of 750 was used (SR-23 manufactured by KONISHI CHEMICAL IND., LTD.). A polysilsesquioxane material was prepared by dissolving 70 g of the polysilsesquioxane with 30 g of a solvent (ethyl carbitol), and the polysilsesquioxane material was used as a coating agent. Then, this coating agent was printed on a surface of glass film 4 and filled in trimming grooves 21, dried at 120° C./30 minutes, and then cured at 200° C./1 hour to form cover part 131. Since the coating agent of Example 1 contains no inorganic filler, the viscosity was lower than that of coating agents of Examples 2 and 3, and the coating agent spread more than glass film 4, thus printing was difficult to control.

### Example 2

A mixture obtained by adding 40 g of silica having an average particle size of 1.5 μm to 14.3 g of the polysilsesquioxane material of Example 1 (polysilsesquioxane solid content: 10 g) was used as a coating agent. Except for this, the same procedure as in Example 1 was performed.

### Example 3

A mixture obtained by adding 15 g of kaolin having an average particle size of 1.4 μm to 14.3 g of the polysilsesquioxane material of Example 1 (polysilsesquioxane solid content: 10 g) was used as a coating agent. Except for this, the same procedure as in Example 1 was performed.

### Example 4

The square chip resistor (electronic component 10) illustrated in FIG. 4 was made according to the steps illustrated in FIGS. 2A to 2C and FIGS. 3A to 3H. In this case, precoated glass (glass film 4) was not formed. In addition, the same coating agent as in Example 2 was used. Except for these, the same procedure as in Example 1 was performed.

### Comparative Example

FIG. 5 is a sectional view illustrating electronic component 10X of Comparative Example. Electronic component 10X (square chip resistor) illustrated in FIG. 5 was made according to the steps illustrated in FIGS. 2A to 2C and FIGS. 3A to 3H. In this case, the procedure was the same as in Example 1 except that a cover part containing a cured product of polysilsesquioxane was not formed. Through hole 41 and trimming groove 21 are filled with the resin of resin layer 5.

### Reference Example

A square chip resistor having the same configuration as that of Example 1 except that the through hole and the trimming groove were not formed was prepared.

### Evaluation 1

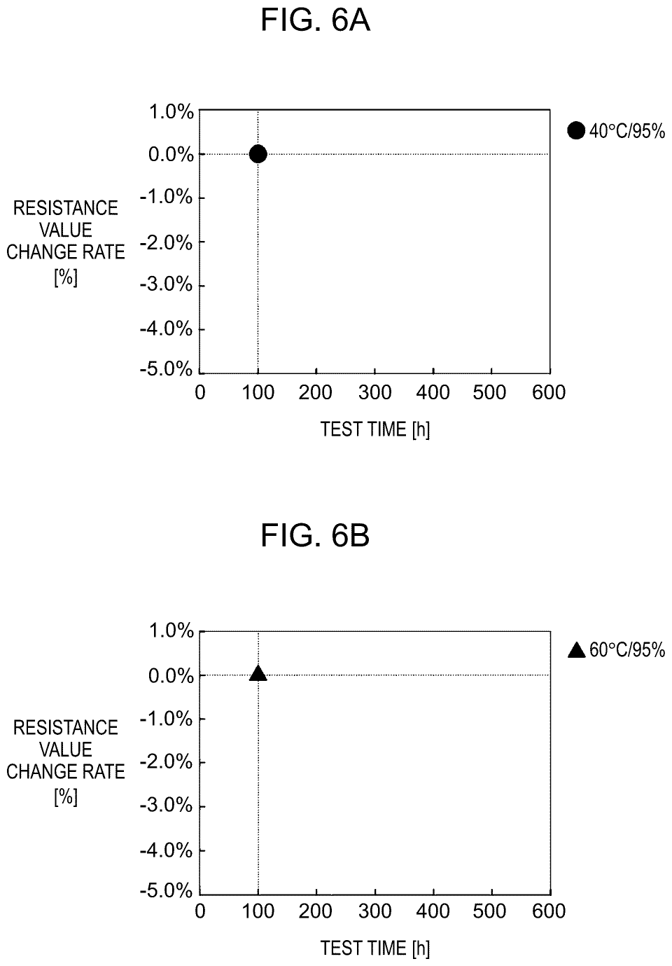

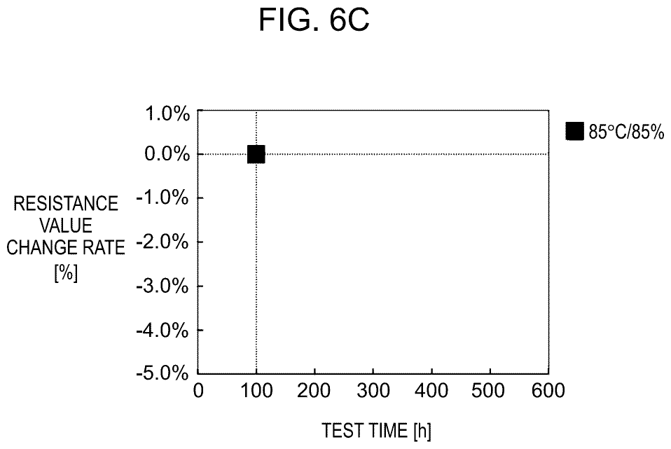

A humidity resistance test was performed on Reference Example. That is, after the initial resistance value of Reference Example was measured, the resistance value after the lapse of 100 hours at an applied voltage of 150 V under three types of temperature/humidity conditions (40° C./95%, 60° C./95%, 85° C./85%) was measured, and the resistance value change rate from the initial value was determined. The number of Reference Example measured under each temperature/humidity condition was 30, and the average resistance value change rate is shown in FIGS. 6A to 6C. That is, FIGS. 6A to 6C are graphs showing the test time and the resistance value change rate in the humidity resistance test of Reference Example for respective conditions. FIG. 6A is a graph showing the value of the resistance value of the chip resistor according to Reference Example after the lapse of 100 hours at an applied voltage of 150 V under conditions of a temperature of 40° C. and a humidity of 95%. FIG. 6B is a graph showing the value of the resistance value of the chip resistor according to Reference Example after the lapse of 100 hours at an applied voltage of 150 V under conditions of a temperature of 60° C. and a humidity of 95%. FIG. 6C is a graph showing the value of the resistance value of the chip resistor according to Reference Example after the lapse of 100 hours at an applied voltage of 150 V under conditions of a temperature of 85° C. and a humidity of 85%. Under any temperature/humidity condition, the resistance change rate of the chip resistor according to Reference Example was 0.0%, and it was found that there was no resistance value change unless the trimming groove was formed.

### Evaluation 2

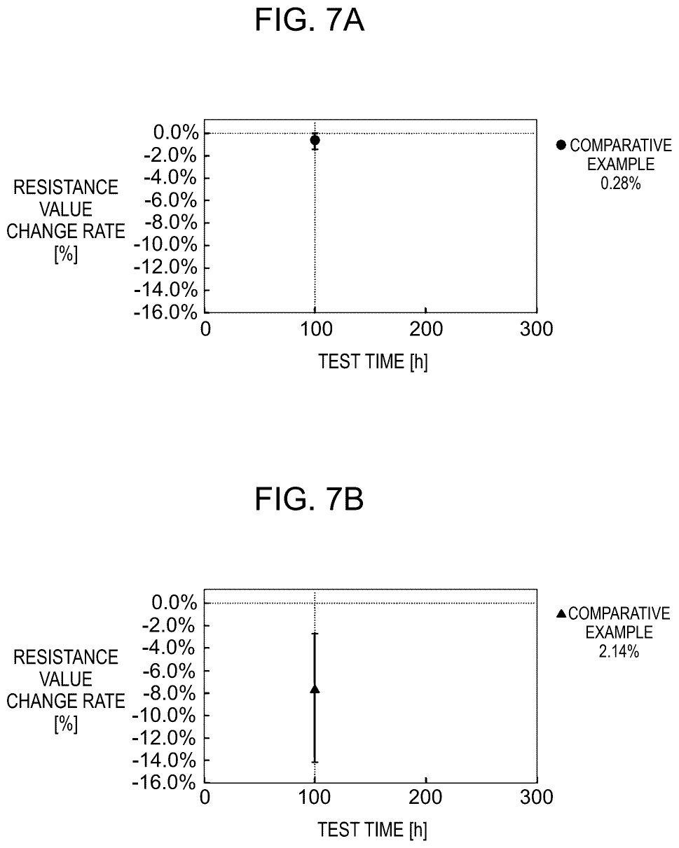

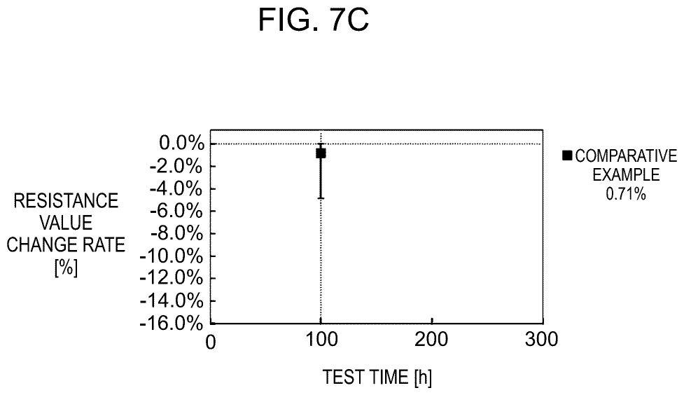

In Comparative Example, three different chip resistors were prepared in which resin layer 5 of insulating protective layer 13 had water absorption rates of 0.28%, 2.14%, and 0.71%, respectively. For the chip resistors of Comparative Example, the initial resistance value was measured, and then the resistance value after the lapse of 100 hours at temperature/humidity conditions of 85° C./85% and an applied voltage of 150 V was measured to determine the resistance value change rate from the initial resistance value. The number of the chip resistors including insulating protective layer 13 having resin layer 5 according to each water absorption rate is 30, and the average resistance value change rate is shown in FIGS. 7A to 7C. That is, FIGS. 7A to 7C are graphs showing the test time and the resistance value change rate in the moisture resistance test of the chip resistor according to Comparative Example including insulating protective layer 13 having resin layers 5 with different water absorption rates. FIG. 7A is a graph showing the test time and the resistance value change rate in the moisture resistance test of the chip resistor in the case of resin layer 5 having a water absorption rate of 0.28%. FIG. 7B is a graph showing the test time and the resistance value change rate in the moisture resistance test of the chip resistor in the case of resin layer 5 having a water absorption rate of 2.14%. FIG. 7C is a graph showing the test time and the resistance value change rate in the moisture resistance test of the chip resistor in the case of resin layer 5 having a water absorption rate of 0.71%. From the results of (Evaluation 2), it was found that the higher the water absorption rate of resin layer 5 included in insulating protective layer 13, the larger the resistance value change rate.

The water absorption rate was determined with the following formula by curing only the resin of resin layer 5 of insulating protective layer 13, measuring the initial mass of the cured film of the resin of resin layer 5, and measuring the mass after leaving the cured film for 500 hours under the conditions of a temperature of 85° C. and a humidity of 85%.

Water absorption rate (%)={(mass after leaving)−(initial mass)}/(initial mass)×100

### Evaluation 3

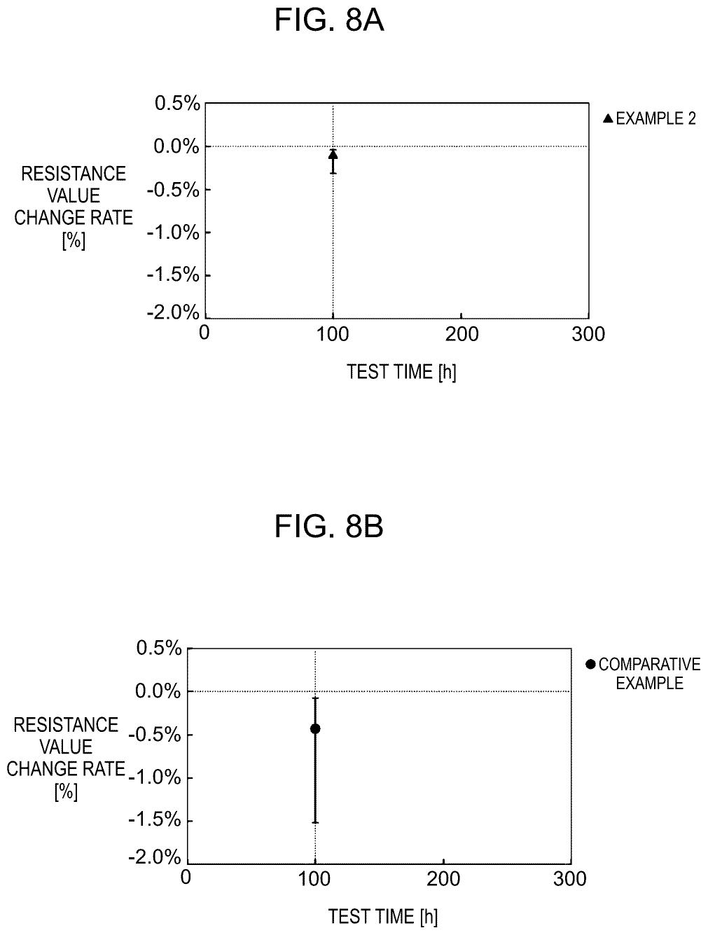

The chip resistor according to Example 2 and the chip resistor according to Comparative Example were subjected to a moisture resistance test. In both the chip resistor according to Example 2 and the chip resistor according to Comparative Example, the water absorption rate of resin layer 5 of insulating protective layer 13 was 0.28%. In the humidity resistance test, the initial resistance value of each of the chip resistor according to Example 2 and the chip resistor according to Comparative Example was measured, thereafter the temperature/humidity conditions were set to 85° C./85%, the chip resistor resistance value after the lapse of 100 hours at an applied voltage of 150 V was measured, and the resistance value change rate from the initial resistance value was obtained. The number of each of the chip resistors of Example 2 and the chip resistors of Comparative Example is 30, and the average resistance value change rate is shown in FIGS. 8A and 8B. That is, FIG. 8A is a graph showing the test time and the resistance value change rate in the humidity resistance test of the chip resistor according to Example 2. FIG. 8B is a graph showing the test time and the resistance value change rate in the humidity resistance test of the chip resistor according to Comparative Example.

Table 1 shows the resistance change rate of Examples 1 to 4 and Comparative Example when the humidity resistance test of (Evaluation 3) was performed.

TABLE 1

| | Resistance change rate (%) | | |
|---|---|---|---|
| | Average value | Minimum value | Maximum value |
| Example 1 | −0.3 | −0.1 | −0.6 |
| Example 2 | −0.1 | −0.1 | −0.3 |
| Example 3 | −0.1 | −0.1 | −0.3 |
| Example 4 | −0.2 | −0.1 | −0.4 |
| Comparative | −0.45 | −0.1 | −1.5 |
| Example | | | |

### INDUSTRIAL APPLICABILITY

The electronic component according to the present disclosure can reduce the hygroscopicity of the insulating protective layer with the cover part containing polysilsesquioxane, making the element part less likely to be affected by moisture and having a small change in characteristics due to moisture. Thus, the moisture resistance of the electronic component improves. The electronic component according to the present disclosure is industrially useful as described above.

### REFERENCE MARKS IN THE DRAWINGS

1: substrate
2: element part
21: trimming groove
4: glass film
10, 10X: electronic component
13: insulating protective layer
131: cover part
132: surface cover layer
133: filling part

1. An electronic component comprising:
a substrate;
an element part disposed on the substrate;
and an insulating protective layer covering the element part,
wherein the element part includes a trimming groove,
the insulating protective layer includes a cover part containing a cured product of polysilsesquioxane, and
the cover part includes:
a surface cover layer covering a surface of the element part; and
a filling part filled in the trimming groove.

2. The electronic component according to claim 1,
wherein the cover part further contains an inorganic filler,
a content of the cured product of polysilsesquioxane in the cover part ranges from 10 mass % to 50 mass % inclusive, and
a content of the inorganic filler in the cover part ranges from 50 mass % to 90 mass % inclusive.

3. The electronic component according to claim 1,
wherein the surface cover layer has a thickness of from 1 μm to 30 μm inclusive.

4. The electronic component according to claim 1,
wherein a terminal group of the polysilsesquioxane contains an ethoxy group.

5. The electronic component according to claim 1,
wherein the polysilsesquioxane includes at least one of a phenyl group or a methyl group in a skeleton.

6. The electronic component according to claim 1,
wherein the cover part covers an entire upper portion of the element part in plane view of the element part.

7. The electronic component according to claim 1, wherein
the insulating protective layer further includes a glass film disposed on the surface of the element part,
the surface cover layer is disposed on a surface of the glass film, and
the filling part penetrates the glass film and is filled in the trimming groove.

8. The electronic component according to claim 1, wherein
the insulating protective layer further includes a resin layer disposed on a surface of the surface cover layer, and
the surface cover layer is disposed on the surface of the element part.
